(19) United States
(12) Patent Application Publication
(10) Pub. No.: US 2008/0104699 A1
(43) Pub. Date: May 1, 2008

(54) SECURE SERVICE COMPUTATION

(75) Inventors: Alexander G. Gounares, Kirkland, WA (US); William H. Gates, Medina, WA (US); Raymond E. Ozzie, Seattle, WA (US); Gary W. Flake, Bellevue, WA (US); Christopher W. Brumme, Mercer Island, WA (US); Nishant V. Dani, Redmond, WA (US); Matthew B. MacLaurin, Woodinville, WA (US); Henricus Johannes Maria Meijer, Mercer Island, WA (US); Debi P. Mishra, Bellevue, WA (US); Amit Mital, Kirkland, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/536,595

(22) Filed: Sep. 28, 2006

(51) Int. Cl. G06F 12/14; G06F 11/00; G06F 12/16; G06F 15/18; G08B 23/00

(52) U.S. Cl. 726/22; 726/23; 726/24; 726/25

(57) ABSTRACT

Systems and methods for managing cloud service applications are provided. In particular, a security component can regulate such applications to prevent undesirable behavior. In one instance, applications can be restricted to use of designated network resources to thereby contain application activities. Additionally or alternatively, the applications can be monitored and prohibited from executing malicious code such as that associated with a virus, worm and/or Trojan horse, among other things.

### BACKGROUND

Computer systems provide a centralized source of valuable information that is often subject to attack. Systems are attacked by different people with disparate motives in a myriad of ways. Malicious hackers such as terrorists and hobby hackers are one category of people that attack computer systems. Terrorists or terror organizations can seek to steal information, damage or shut down systems to further their political and/or economic agendas. Hobbyists attempt to penetrate systems and cause damage for sport, to demonstrate their technological prowess and/or to expose vulnerabilities. Tools of malicious hackers can include viruses, worms, Trojan horses and other types of malware. Another category of people that attack systems is insiders. These people are often disgruntled employees who seek to utilize their authorization and knowledge of a system to appropriate or destroy information and/or shut the system down. While harm caused by attacks can vary, as a whole the cost in terms of time, money and privacy can be astronomical.

Various security software and/or packages are conventionally employed to combat hostilities with respect to computer systems. Such security software is device centric. In practice, a device is initially scrutinized by security software to locate and remove malicious or suspicious software (e.g., viruses, worms, spy ware . . . ). Furthermore, security settings or preferences can be set in an attempt to balance usability with protection. Thereafter, it is assumed that a device is safe or trusted and attempts are made to thwart outside malicious activity from affecting the device. This can be done by monitoring incoming data, ports, and device executable software for suspicious activity. A user or administrator can be notified upon detection of suspicious activity and to provide guidance with respect to any action to be taken. For example, a user can choose to allow a particular program to execute or block access to a process attempting to access a machine. In essence, the described security software attempts to prevent unauthorized device access. Other security mechanisms can be utilized to protect information should the prevention fail.

For example, data can be encrypted to protect the content thereof. Encryption can render content unintelligible to unauthorized individuals. A complex mathematical algorithm is employed to encode data in accordance with an encryption key (e.g., public key). In this manner, only authorized users with the appropriate key (e.g., private key) can decrypt the encoded data and retrieve the original context. This technology can be employed to lock individual files or groups of files or file folders on a device. This provides a level of protection with respect to content. However, if the goal of malicious code is corruption or deletion encrypted data is just as vulnerable as unencrypted data.

### SUMMARY

The following presents a simplified summary in order to provide a basic understanding of some aspects of the claimed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to secure computation with respect to computer applications. Rather than or in addition to concentrating efforts on protecting a particular hardware device, the subject innovation focuses on secure production and execution of applications that are in a sense guaranteed not to perform prohibited activities such as implementation of malicious code or accessing restricted computational resources. More specifically, security can be imposed on network or cloud service applications that in some cases can be distributed across multiple cloud resources.

In accordance with one aspect of the subject disclosure, a security component is provided that can interact with cloud service applications to ensure at least a degree of safe and/or secure execution. In particular, the security component can analyze a service application to determine and/or infer whether it includes prohibited behavior. Action can then be initiated where prohibited behavior is found. The action can seek to remedy the issue, for example by removing and/or modifying code responsible for the proscribed behavior. Additionally or alternatively, the action can prevent code in execution from performing the particular behavior, for instance by disallowing access to one or more computational resources.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a secure computation system.

FIG. 2 is a block diagram of a secure computation system within a cloud.

FIG. 3 is a block diagram of a representative security component.

FIG. 4 is a block diagram of a representative analyzer component.

FIG. 5 is a block diagram of a representative signature component.

FIG. 6 is a block diagram of a representative action component.

FIG. 7 is a block diagram of a secure environment for execution of cloud services.

FIG. 8 is a block diagram of a secure service development system.

FIG. 9 is a flow chart diagram of a method of secure computing.

FIG. 10 is a flow chart diagram of a method of secure computing based on application trustworthiness.

FIG. 11 is a schematic block diagram illustrating a suitable operating environment for aspects of the subject innovation.

FIG. 12 is a schematic block diagram of a sample-computing environment.

### DETAILED DESCRIPTION

Provided herein are systems and methods to facilitate computational security. While conventional security mechanisms focus on device centric security, the subject innovation pertains to securing network based cloud services. These services can be analyzed and action taken to constrain behavior. In one instance, a service can be limited to employment of particular resources. Additionally or alternatively, mechanisms can be employed to assure that the service does not engage in malicious activity.

The aforementioned functionality can be performed at least in part by a security component. This component can be embodied in a number of different systems that alone or in combination contribute to the security of cloud service applications. For instance, the security component can be a service itself, embodied within an execution environment and/or employed in an application development system, among other things.

Various aspects of the subject innovation are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

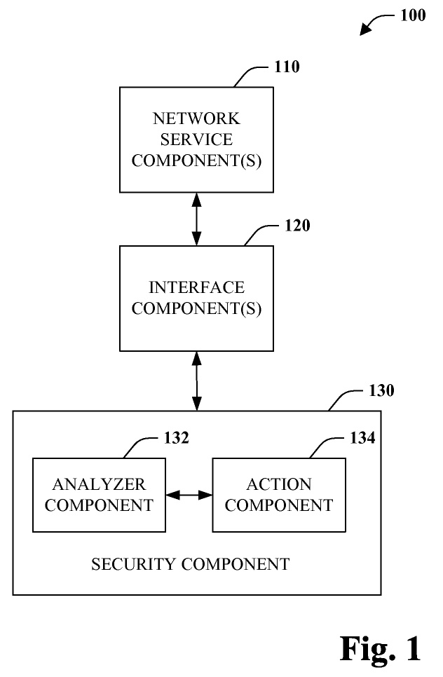

Referring initially to FIG. 1, a secure computation system 100 is illustrated in accordance with an aspect of the subject disclosure. Network service component(s) 110, or cloud services 110 as they are also termed herein, are network-based applications that afford remote functionality via hardware and/or software network resources including, without limitation, data, logic and processes. Network services 110 can also include application services and/or web services. Furthermore, such services 110 or associated functions thereof can be segmented and distributed across multiple machines or like hardware for processing. By way of example, a network or cloud service 110 can provide functionality associated with conventional office products such as word processing, spreadsheets, presentations and the like as remote and network accessible services. In this instance, user data, code, queries, applications and/or the like can be created, persisted and/or manipulated with respect to remote stores by employing one or more services with a thin client device. Accordingly, network services 110 are not confined to a particular computing machine or device, as is the convention. In fact, the network services 110 can in some instances be distributed such that service processing is shared amongst a plurality of disparate and remotely located resources.

The network services component(s) 110 are communicatively coupled to interface component(s) 120, which are similarly coupled to security component 130. The interface component(s) 120 facilitate communication between the network services component(s) 110 and the security component 130. In one embodiment, the interface component(s) 120 can correspond to application programming interfaces, wherein the interface component(s) 120 implement program calls for both the network service component(s) 110 and the security component 130 and provided translations between them. For instance, the security component 130 can request and receive data from a network application via the interface component 120, which can perform translation between protocols. Note also that while illustrated separately, the interface component(s) 120 can form part of one or both of the network service component(s) 110 and the security component 130.

The security component 130 interacts with the network service component(s) 110 to ensure safe and/or appropriate programmatic behavior. More specifically, the security component 130 includes an analyzer component 132 that analyzes the network service 110 to detect or infer unsafe or inappropriate activity. For example, the analyzer component 132 can detect malicious activity such as a virus by comparing code or actions thereof to virus patterns or signatures as described in further detail hereinafter. Additionally or alternatively, the analyzer component 132 can scrutinize the manner and/or usage of particular resources to identify proper or improper utilization in accordance an execution policy and/or trust metric, inter alia.

The analyzer component 134 is communicatively coupled to action component 136 to facilitate response to a condition identified by the analyzer component 134. The response taken can seek to remedy the condition and/or preemptively prevent an act from occurring. By way of example, the analyzer component 132 can detect a virus in the network service 110 via a match to a known virus signature and relay a message to action component 134 for response. The action component 134 can then remove the virus. Similarly, the analyzer component 132 can determine the network service 110 includes malicious code capable of taking over or corrupting a data center and the action component 134 can prevent such action by disallowing connection to the data center. Note also that actions need to be confined to remedying conditions. They can also be associated with notification of appropriate authorities, groups and/or developers, among other things.

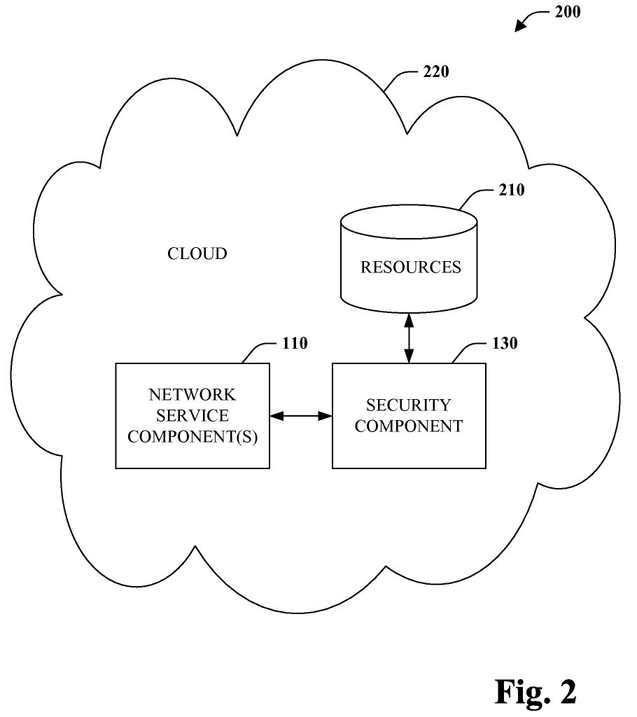

FIG. 2 illustrates a secure computation system 200 in accordance with an aspect of the disclosure. The system 200 includes network service component(s) 110 and security component 130, as described supra with respect to system 100 of FIG. 1 as well as resources 210. Each of these components resides within a cloud 220, which is a collection of remotely provided and maintained network accessible resources 210 including hardware and/or software. For instance, the resources 210 can include a mainframe or server farm that houses a pool of data associated with the cloud. Additionally or alternatively, the resources 210 can pertain to processing power for execution of services and/or communication bandwidth amongst service components or with client devices, among other things. The network service component(s) 110 are cloud based services that provide network accessible functionality, for instance with respect to resources 210. The security component 130 facilitates secure operation of network service component(s) 110. Here, however, the security component 130 is a network or cloud service communicatively coupled the network service component(s) 110. In other words, the security component 130 is a service that provides security functionality with respect to other services. For instance, the security component 130 can detect and remove malicious code from one or more network service components 110. Furthermore, the security component 130 can intervene and prohibit or control access to resources 210.

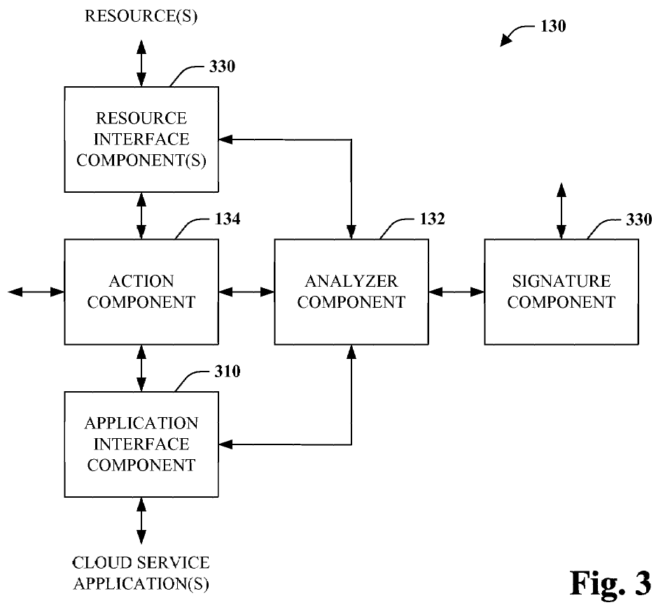

Turning attention to FIG. 3, a representative security component 130 is depicted in accordance with an aspect of the disclosure. Network or cloud service applications can interact with the security component 130 by way of application interface 310. In one instance, a cloud service can request use and/or interaction with resources such as a data store utilizing the application interface component 310. Resource interface component 320 provides a mechanism to enable interaction and/or provisioning of resources. The action component 134 is communicatively coupled to both the interface components 310 and 320. In addition, the action component 134 is coupled with the analyzer component 132. The analyzer component 134 analyzes data, information and requests, among other things, following from one or both of the application interface component 310 and the resource interface component 320.

The analysis can seek to ensure that applications safely and/or securely interact with resources. The analysis can be embodied in a set of logic rules or procedures. Here, for instance, the analyzer component 132 can interact with signature component 330, which supplies or otherwise makes accessible patterns or signatures indicative of insecure and/or secure behavior. The analyzer component 132 can then identify, infer or predict improper activity based on the data from one or more of the interface components 310 and 320 in conjunction with signature information from component 330. Information can be sent from the analyzer component 132 to the action component 134 to initiate performance of some action to ensure safe and/or secure operation.

By way of example, the action component 134 can act as a gateway and prohibit access to particular resources. Alternatively, if the action is determined or inferred to be safe or free from malicious behavior, the action component 134 can allow or facilitate provisioning of resources via the machine interface component 320 and the application interface component 310. For instance, a code segment can be loaded and remotely processed by cloud resources and results provided back to a cloud service application. In another instance, a data store can be made accessible to a cloud service for interaction.

Note that concepts described thus far generally provide one level of security defense. For example, code cannot be executed that does not match a known good signature or alternatively matches a bad signature. However, there can still be issues where nominally “good” code can take over a system (e.g. via a denial of service type attack by consuming too many resources either intentionally or unintentionally). These scenarios are a grey zone between purely evil or bad code and purely good code. This is where otherwise good code is tricked to doing something unintended. One approach to dealing with this problem is to introduce a quota system executed by one or more of the analysis and action components 132 and 134, respectively. More particularly, any code that runs is associated with some amount of resources it is allowed to use. This limit can be static, or it can be dynamic (e.g., set by an auction pricing model). The amount of resources utilized and/or requested can be monitored and action taken to prevent employment of resources in excess of a designated amount. As a result, one can be confident that an associated system executes only code known to be good, and it is contained within some known constraints so that even if it does go haywire in some unintended way, it will be bounded within some overall limits.

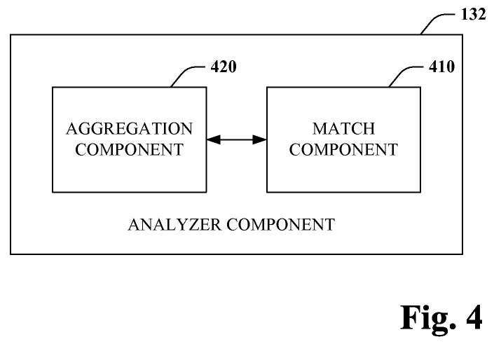

FIG. 4 depicts a representative analyzer component 132 according to an aspect of the disclosure. Included is a match component 410 that enables matching of particular patterns or signatures with application data, information, code, functionality or the like. Further provided is an aggregation component 420 that is communicatively coupled to the match component 410. It should be appreciated that a network or cloud service application can be distributive in nature wherein portions of the application are processed by different resources (e.g. machines, servers, processors . . . ). In this manner, it can be difficult to detect malicious activity that is distributed amongst disparate processes and/or resources. The aggregation component 420 can aggregate information that pertains to distributed applications as identified or otherwise determined thereby and provide this aggregated information to the analyzer component match component 410. The match component can then employ the aggregated information to help identify or infer a matching activity pattern.

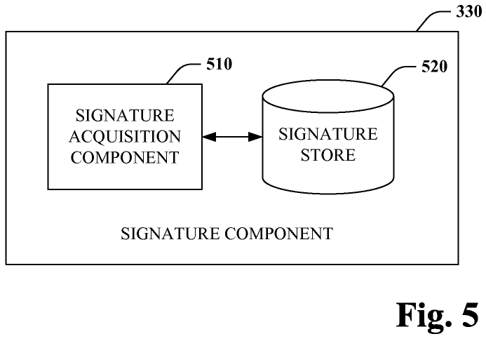

FIG. 5 illustrates a representative signature component 330. The component 330 can provide patterns or signatures for comparison to facilitate identification of malicious service behavior. The signature component 510 includes a signature acquisition component 510 that can receive, retrieve or otherwise obtain or acquire one or more signatures. For example, the acquisition component 510 can monitor a network, such as the Internet or specific sites provided thereby, or cloud to locate signatures indicative of malicious service activity. More specifically, a plurality of queries can be generated to locate patterns of malicious conduct. Blogs, social networks and other like mechanisms can also be employed for the same purpose. The located signatures can be persisted to signature store 520 and made available for use by analyzer component 132 (FIG. 3).

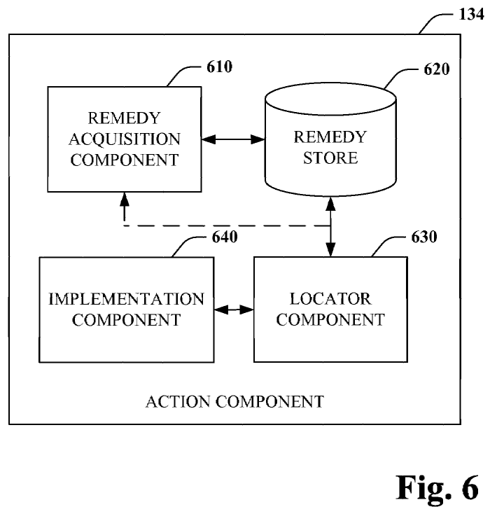

A representative action component 134 is depicted by FIG. 6. The action component 134 provides a number of actions for responding to identified or inferred malicious and/or suspicious code associated with a cloud service. Remedy acquisition component 610 provides a mechanism for receiving, retrieving or otherwise acquiring information concerning responses identified malicious code. A remedy can provide one or more actions that can be performed to respond to malicious and/or suspicious service code, among other things. The remedy may be made available coincidentally with malicious code signatures. However, there can be scenarios in which malicious code is identifiable, but a remedy not yet available. In these cases, the remedy acquisition component 610 can check for available remedies on demand, continually or periodically, for example by searching network resources or polling a particular store or service. Located remedies can be saved to remedy store 620. Additionally or alternatively, there can be a default remedy such as temporarily suspending a program, terminating execution and/or continuing execution in a secure sandbox.

Locator component 630 locates a remedy or associated actions for a particular malicious behavior, for instance as determined by the analyzer component 132 (FIGS. 3 & 4). The locator component 630 is communicatively coupled to the remedy store 620 and is operable to query the store for the required remedy. If located in the store 620 the remedy can be provided to implementation component 640. Alternatively, the locator component 630 can communicate with the acquisition component 610 and notify it of the need for a particular remedy. The acquisition component 610 can acquire and provide the remedy to the locator component 630 directly or indirectly through the store 620.

The implementation component 640 implements or executes actions specified by a provided or otherwise acquired remedy. By way of example, the implementation component 640 can execute actions that prevent access to resources (e.g., data store, processors . . . ) and/or remove malicious code. Additionally or alternatively, notifications can be generated and provided to responsible individuals.

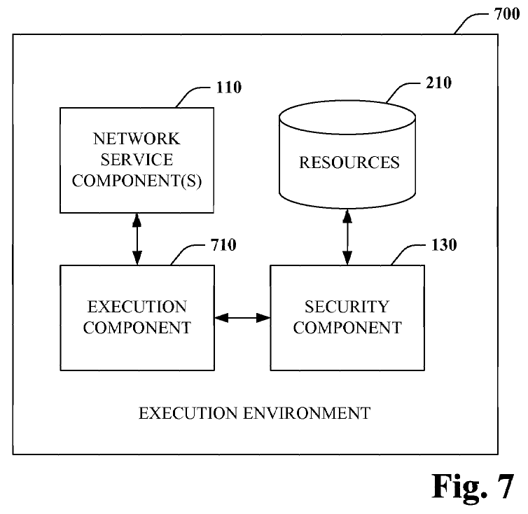

FIG. 7 depicts an execution environment 700 that employs the security component 130 in accordance with an aspect of the subject disclosure. The execution environment 700 provides a framework for application execution and more particularly cloud services. In accordance with one aspect of the disclosure the execution environment 770 can itself be a network or cloud service. For example, execution environment 700 can correspond to a cloud-based operating system that initiates and manages other cloud services. As shown, the environment 700 includes one or more network service components 110. These service components 110 can be executed or run by the execution component 710. Programmatic constructs and instructions associated with a service can be executed in predefined order by component 710 to provide the functionality captured thereby. Execution of a service can involve at least one resource (e.g., hardware and/or software) 210. Such resources 210 pertain to those that are managed by the execution environment 700 and employable by execution component 710. For example, the resources 210 can include data stores, programmatic libraries, processing power and memory, among other things.

The security component 130 is communicatively coupled to the execution component 710 and the resources 210. In this manner, the security component 130 can control access to the resources by network service components 110. The security component 110 can thus protect the resources by acting as a proxy for the execution component 710 such that requests for resources can be made through the security component 130. Requests can be analyzed and if safe, the resources can be made available for use by the execution component 710, for instance directly or indirectly via security component 130. However, if use is suspicious or otherwise determined to be unsafe and/or insecure, the security component 710 can inject itself and prevent usage of the resources as desired. For instance, if it is determined that a malicious service is attempting to take control of processing resources or inject a virus into the system, the security component 130 can deny the service access to the resources.

Furthermore, the security component 130 can create a security sandbox, wherein access to particular resources is restricted. For instance, the security component 130 can ensure that network service component(s) 110 are only able to access the resources 210 of the execution environment 700. While this can be beneficial for program testing, use thereof is not restricted to that purpose. Such functionality can also be utilized to limit the effects of programs on resources outside the execution environment and thereby mitigate dangers to other resources.

Still further yet, the security component 130 can execute a quota system to restrict that amount of resources accessible to network service components in accordance with an associated limit. This limit can be static, or it can be dynamic (e.g., set by an auction pricing model). Consequently, the execution environment can ensure that only code known to be good is executed and it is restrained by some constraints so that even if it does behave badly in some unintended way, it will be bounded within some overall limits.

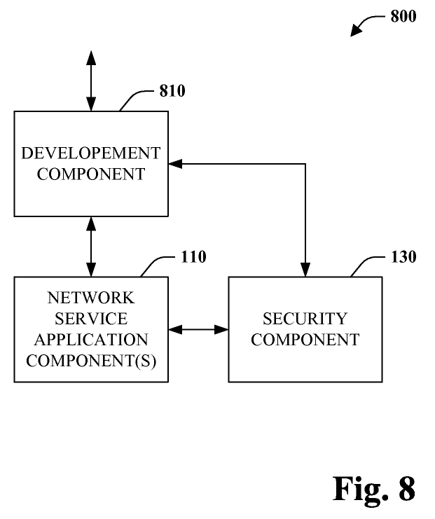

Referring to FIG. 8, a secure development system 800 is depicted in accordance with an aspect of the disclosure. Development component 810 provides a mechanism to facilitate generation of a network service component 110. For example, the development component 810 can correspond to an integrated development environment (IDE) that provides a code editor, debugger and various automation tools such as auto fill, among other things. In essence, features are provided by the developer component to assist users with specification of a network service.

The security component 130 is communicatively coupled to both the development component 810 as well as the network service component 110 and is operable to assist in service development and deployment. More specifically, the security component 130 can analyze the network service component 110 and provide security feedback to the development component. By way of example, the security component can detect attempted use of a restricted behavior and notify a programmer of this problem via the development component 810. The notification can take the form of a squiggly line under the code segment and/or tool tip that provides specific information about the security violation, for example. Moreover, the security component 130 can interact with the development component 810 to prohibit generation of a service with security violations, for instance by not providing tools that assist and/or allow a user to code a service that violates a security policy, inter alia. Likewise, the security component 810 can monitor code generation with respect to malicious code signatures and communicate such information to the developer component 810, prohibit specification malicious code and/or comment out malicious code. In this way, code including viruses and the like can be detected and eliminated at the development level, prior to execution.

It should be noted that employment of the development system 880 does not exclude use of other security mechanisms such as those that involve analyzing code execution. In fact, such mechanisms can be combined to generate useful and innovative features. For example, runtime security monitoring and/or analysis can be based on a metric of trustworthiness. In other words, a runtime security component or system and monitor applications differently depending on the level of trustworthiness associated with the application. While trustworthiness can be associated with an individual developer or company, it can also be based on other factors such as the development environment from which the service is generated. In particular, a service developed utilizing a secure system such as system 800 can be deemed more trustworthy than applications that do not employ such a system. Accordingly, execution analysis can be looser in that actions that would otherwise trigger a response need not. In this scenario, the development environment can embed a code in the application that is identifies the environment and/or provides a means to certify that the program was developed and/or analyzed by a particular secure system. Similar and/or additional mechanisms can also be utilized to base trustworthiness on developer identity and application authentication. In this manner, trustworthiness can be increased based on identifiable and responsible parties.

It should also be noted that code can be proof carrying. In other words, the code can provide some evidence (e.g., formal) that it is secure. Proof carrying code can be scrutinized by the security component 130 to ensure it has an appropriate proof or evidence prior to execution. If not, the execution can be prevented.

Furthermore, note that the provided systems and/or components associated with secure computation can be made extensible. More particularly, these systems and/or components can allow users to also upload their own analyzer components, action components, signature components, security components or the like. This allows for a higher-order cloud (e.g., a cloud parameterized by a cloud) as opposed to a first-order cloud. By way of example, the system can host services of a company that wants to enforce their own security policies. Further, the system can be modified to be able to host different execution components (e.g., CLR, unmanaged code, JVM, AS400 . . . ). Still further yet, the system can allow and enable plug in of third-party virus scanners. In this case, the security component 130 can act as a meta-security component that will ensure the secure execution of downloaded components.

The aforementioned systems, architectures and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. The components may also interact with one or more other components not specifically described herein for the sake of brevity, but known by those of skill in the art.

Furthermore, as will be appreciated, various portions of the disclosed systems and methods may include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

By way of example and not limitation, the security component 130 can utilize such mechanisms to infer potential security issues based on characteristics of a plurality signatures of known security problems. In this manner, the security component 130 can automatically identify new security threats and/or potential security vulnerabilities. Similarly, the security component 130 can employ such techniques to locate or even generate responses that remedy identified or inferred security issues. For instance, if malicious code is discovered which attempts to corrupt and/or delete data from a store, the security component can infer that it should block access to the store to prevent damage.

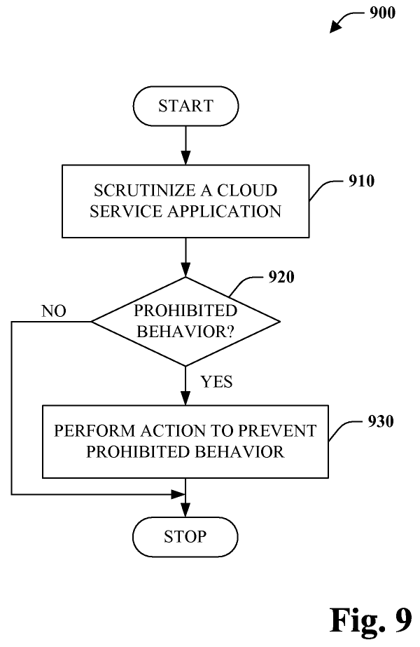

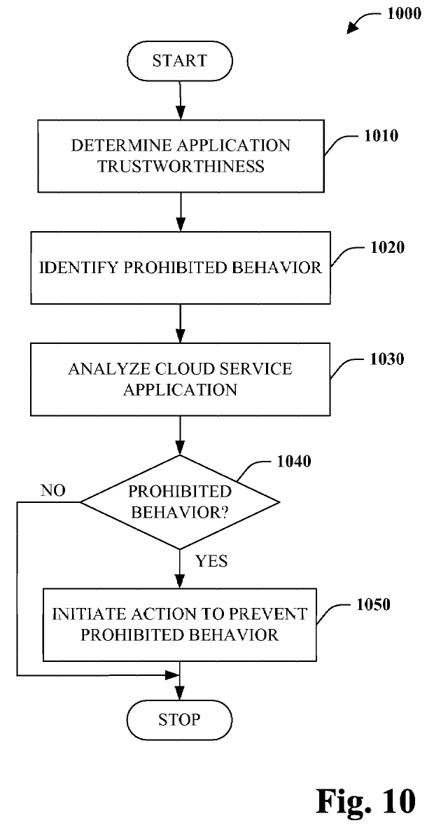

In view of the exemplary systems described supra, methodologies that may be implemented in accordance with the disclosed subject matter will be better appreciated with reference to the flow charts of FIGS. 9 and 10. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Referring to FIG. 9, a method of secure computing 900 is depicted in accordance with an aspect of this disclosure. In view of the push of resources and functionality into a cloud, it is important to ensure that cloud service applications behave. Provided is a method 900 that facilitates securing such applications. At reference numeral 910, a cloud service application is scrutinized. The act of scrutinizing or otherwise analyzing such an application can be performed at runtime, prior to runtime (e.g., development) or both. A determination is made at numeral 920 as to whether the service application includes or is attempting to perform prohibited behavior. The prohibited behavior can vary in accordance with a particular security policy associated with the application or environment. However, such behavior can include malicious code (e.g. virus, worm, denial of service, data corruption and/or deletion . . . ) as well as access and/or use of particular resources (e.g., designated, non-designated). No action needs to be implemented if at 920 it is determined that that application is well behaved. However, if, at 920, prohibited behavior is identified or inferred, then the method 900 can proceed to 930. At numeral 930, action can be performed to prevent the prohibited behavior. For example, if the prohibited behavior relates to malicious code such as a virus, then the action can pertain to removal of that code, and/or prevention execution thereof. Alternatively, if the behavior concerns access to non-designated resources, then the action or remedy can simply block access to the resources. It is to be appreciated that the action is dependent upon the identified or inferred security threat and application state. For instance, a remedy may be different for a cloud service in execution, then for one in development. Once the action is performed at 930, the method can simply terminate. By analyzing cloud service applications prior to and/or during execution for restricted activity and affording a remedy, these service applications can be guaranteed to be safe, at least to a degree.

Turning attention to FIG. 10, a method of secure computing 1000 that accounts for trustworthiness is illustrated in accordance with an aspect of this detailed description. At reference numeral 1010, cloud service application trustworthiness is determined. Trustworthiness can be established in a myriad of manners. For instance, if an application were produced by a secure development environment it would be deemed more trustworthy than one that had not. Likewise, the identity of the application developer can impact trustworthiness. For example, if the application was developed by a major software vendor the application could be regarded as more trustworthy than an application produced by an individual, or where no identity is associated with the application. While trustworthiness can be relevant, a standardized metric can be employed to facilitate utilization of this application characteristic.

Applications may be allowed to implement disparate levels of functionality based on the level of trust associated with an application. For instance, suspicious activity need not be regarded as such for a trustworthy application generated by a secure development environment. At reference numeral 1020, prohibited behavior can be identified in view of the determined trustworthiness. There can be an inverse relationship here—the greater the level of trust the less activity should be prohibited. Stated differently, the lower the trust associated with a service application, the greater the restrictions.

At reference numeral 1030, the cloud service application is analyzed. The analysis can be based on the identified prohibited behavior as determined at 1020. A determinate can then be made with respect to the analysis as to whether prohibited behavior exists, at numeral 1040. A comparison can be made with respected to identified prohibited behavior and application specified activity. If there is a match, then prohibited behavior has been detected. Alternatively, no prohibited behavior is detected is there is no match. It should also be appreciated that inference can be employed to facilitate identification of prohibited behavior. In such a scenario, additional prohibited activities can be derived from those already provided. Matches can then be determined based on inferred prohibited behaviors. If prohibited behaviors are detected, method 1000 can continue at 1050. Otherwise, the method 1000 can simply terminate or alternatively continue to analyze an application at 1030 (not shown).

At reference numeral 1050, action can be initiated to prevent the identified behavior. Actions are dependent upon application state, among other things. If prohibited behavior is identified in an application during development, then the behavior can be removed or modified to eliminate the security risk. However, if the application is running, then action can relate to blocking the prohibited behavior, for example by not allowing use of resources.

As used herein, the terms “component,” “system,” “service” and the like are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The term “entity” is intended to include one or more individuals/users. These users may be associated formally or informally, for instance as a member of a group, organization or enterprise. Alternatively, entities and/or users can be completely unrelated.

A “cloud” is intended to refer to a collection of resources (e.g., hardware and/or software) provided and maintained by an off-site party (e.g. third party), wherein the collection of resources can be accessed by an identified user over a network (e.g., Internet, WAN . . . ). The resources provide services including, without limitation, data storage services, security services, and/or many other services or applications that are conventionally associated with personal computers and/or local servers.

The word “exemplary” is used herein to mean serving as an example, instance or illustration. Any aspect or design described herein as “exemplary” is not necessarily to be construed as preferred or advantageous over other aspects or designs. Furthermore, examples are provided solely for purposes of clarity and understanding and are not meant to limit the subject innovation or relevant portion thereof in any manner. It is to be appreciated that a myriad of additional or alternate examples could have been presented, but have been omitted for purposes of brevity.

Furthermore, all or portions of the subject innovation may be implemented as a method, apparatus or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

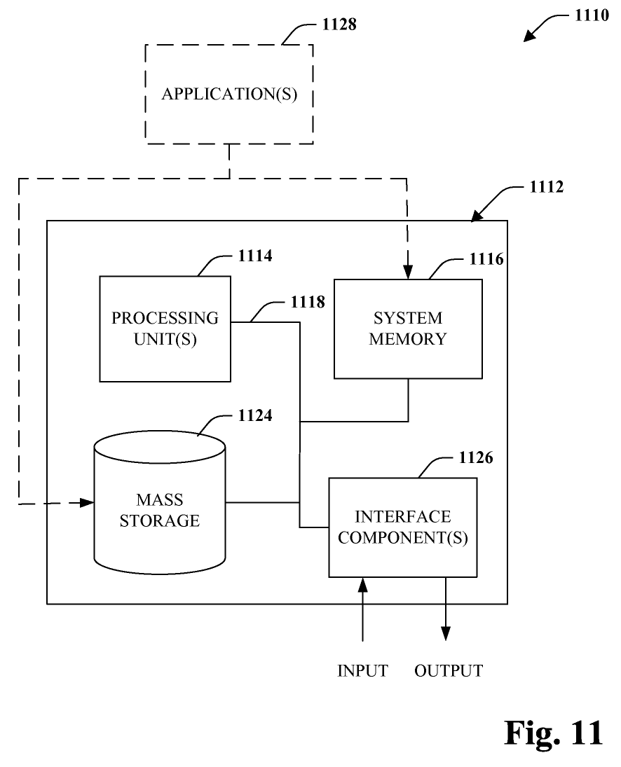

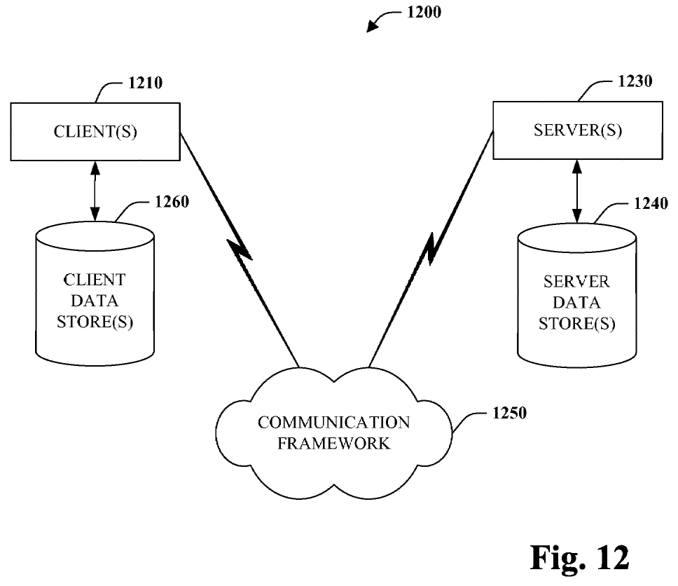

In order to provide a context for the various aspects of the disclosed subject matter, FIGS. 11 and 12 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed innovation can be practiced on stand-alone computers. In a distributed computing environment, program modules may be located in both local and remote memory storage devices.

With reference to FIG. 11, an exemplary environment 1110 for implementing various aspects disclosed herein includes a computer 1112 (e.g., desktop, laptop, server, hand held, programmable consumer or industrial electronics . . . ). The computer 1112 includes a processing unit 1114, a system memory 1116, and a system bus 1118. The system bus 1118 couples system components including, but not limited to, the system memory 1116 to the processing unit 1114. The processing unit 1114 can be any of various available microprocessors. It is to be appreciated that dual microprocessors, multi-core and other multiprocessor architectures can be employed as the processing unit 1114.

The system memory 1116 includes volatile and nonvolatile memory. The basic input/output system (BIOS), containing the basic routines to transfer information between elements within the computer 1112, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 1112 also includes removable/non-removable, volatile/non-volatile computer storage media. FIG. 11 illustrates, for example, mass storage 1124. Mass storage 1124 includes, but is not limited to, devices like a magnetic or optical disk drive, floppy disk drive, flash memory or memory stick. In addition, mass storage 1124 can include storage media separately or in combination with other storage media.

FIG. 11 provides software application(s) 1128 that act as an intermediary between users and/or other computers and the basic computer resources described in suitable operating environment 1110. Such software application(s) 1128 include one or both of system and application software. System software can include an operating system, which can be stored on mass storage 1124, that acts to control and allocate resources of the computer system 1112. Application software takes advantage of the management of resources by system software through program modules and data stored on either or both of system memory 1116 and mass storage 1124.

The computer 1112 also includes one or more interface components 1126 that are communicatively coupled to the bus 1118 and facilitate interaction with the computer 1112. By way of example, the interface component 1126 can be a port (e.g., serial, parallel, PCMCIA, USB, FireWire . . . ) or an interface card (e.g., sound, video, network . . . ) or the like. The interface component 1126 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 1112 to output device(s) via interface component 1126. Output devices can include displays (e.g. CRT, LCD, plasma . . . ), speakers, printers and other computers, among other things.

FIG. 12 is a schematic block diagram of a sample-computing environment 1200 with which the subject innovation can interact. The system 1200 includes one or more client(s) 1210. The client(s) 1210 can be hardware and/or software (e.g., threads, processes, computing devices). The system 1200 also includes one or more server(s) 1230. Thus, system 1200 can correspond to a two-tier client server model or a multi-tier model (e.g., client, middle tier server, data server), amongst other models. The server(s) 1230 can also be hardware and/or software (e.g., threads, processes, computing devices). The servers 1230 can house threads to perform transformations by employing the aspects of the subject innovation, for example. One possible communication between a client 1210 and a server 1230 may be in the form of a data packet transmitted between two or more computer processes.

The system 1200 includes a communication framework 1250 that can be employed to facilitate communications between the client(s) 1210 and the server(s) 1230. Here, the client(s) can correspond to network computing devices and the server(s) can form at least a portion of the cloud. The client(s) 1210 are operatively connected to one or more client data store(s) 1260 that can be employed to store information local to the client(s) 1210. Similarly, the server(s) 1230 are operatively connected to one or more server data store(s) 1240 that can be employed to store information local to the servers 1230. Here, the server(s) 1230 and associated data store(s) 1240 can provide the resources for execution of network or cloud service applications. The client(s) 1210 are related store(s) 1260 can be representative of client devices (e.g., thin clients) that interact with the cloud service applications.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has” or “having” or variations in form thereof are used in either the detailed description or the claims, such terms are intended to be inclusive in a manner similar to the term “comprising” as “comprising” is interpreted when employed as a transitional word in a claim.

What is claimed is:

1. A secure computation system, comprising the following computer-implemented components:
an interface component that facilitates interaction with a cloud service application; and
a security component that prevents execution of prohibited behavior by the application.

2. The system of claim 1, further comprising an analyzer component that identifies the prohibited behavior.

3. The system of claim 2, further comprising an action component that blocks access to at least one application requested resource upon identification of prohibited behavior by the analyzer component.

4. The system of claim 2, further comprising a match component that matches application code to a plurality of signatures representative of prohibited behavior.

5. The system of claim 4, further comprising a signature component that acquires the signatures and persists them to a store.

6. The system of claim 4, further comprising a component that aggregates distributed network application code to aid identification of prohibited behavior via the match component.

7. The system of claim 1, further comprising at least one component that locates and implements a remedy that addresses the prohibited behavior.

8. The system of claim 1, the security component is a network-based service.

9. The system of claim 8, the security component prevents access to resources outside those associated with the execution environment, thereby sandboxing the application.

10. The system of claim 1, the security component is incorporated into an integrated development environment to facilitate development of secure applications.

11. The system of claim 10, the security component removes and/or comments out code that specifies prohibited behavior.

12. A method of secure computing, comprising the following computer-implemented acts:
analyzing a cloud service application for prohibited activity; and
preventing execution of identified prohibited activity.

13. The method of claim 12, further comprising:
receiving requests for network resources from the cloud service application; and
precluding provisioning of the requested resources where prohibited activity is identified.

14. The method of claim 13, further comprising analyzing results returned to the application from the network resources to facilitate identification of prohibited activity.

15. The method of claim 13, further comprising aggregating related requests to facilitate identification of prohibited behavior with respect to distributed applications.

16. The method of claim 12, further comprising identifying a level of trustworthiness associated with the application and altering the prohibited behavior based thereon to enable trustworthy applications to engage a more activity than a less trustworthy application.

17. The method of claim 12, analyzing the applications for attempted access to resources outside those designated for utilization and preventing such activity.

18. The method of claim 12, further comprising locating and applying a remedy to the application to remove the prohibited activity.

19. A system for secure information processing with respect to network service applications, comprising:
means for analyzing a distributed network service application to identify malicious activity; and
means for preventing execution of the malicious activity.

20. The system of claim 19, the means for preventing execution blocks access to undesignated resources.
